(19) United States
(12) Patent Application Publication
(10) Pub. No.: US 2010/0084429 A1
(43) Pub. Date: Apr. 8, 2010

(54) SEALANT APPLYING APPARATUS FOR PRINT HEAD

(76) Inventors: Karina Anne Krawzyzk, Lexington, KY (US); Bart Allan Mansdorf, Lexington, KY (US); Stephen Todd Olson, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/246,587

(22) Filed: Oct. 7, 2008

(51) Int. Cl. B67D 5/56; F16L 41/00; B65D 88/54

(52) U.S. Cl. 222/129; 137/561 A; 222/330

(57) ABSTRACT

A sealant applying apparatus for dispensing sealant onto a nozzle plate of a print head is provided. The nozzle plate includes a plurality of arrays of nozzles. Each array of nozzles of the plurality of arrays of nozzles has a predefined perimetric profile of a nozzle orifice. The sealant applying apparatus includes a barrel and a sealant tip. The barrel is configured to enclose the sealant therein. The sealant tip extends from an end of the barrel and comprises a plurality of sealant outlets. Each sealant outlet is configured to dispense sealant onto an array of nozzles. Further, each sealant outlet is configured such that at least one of a height of each sealant outlet and a perimeter of an exit of each sealant outlet depends upon a predefined perimetric profile of a nozzle orifice of the array of nozzles.

### BACKGROUND

1. Field of the Invention

The present invention relates generally to sealant applying apparatuses, and more particularly to sealant applying apparatuses for applying sealant onto nozzles of print heads having a multitude of sizes of nozzle orifices.

2. Description of the Related Art

Inkjet printers generally use thermal inkjet cartridges that contain an ink supply from a factory. A typical thermal inkjet cartridge may include a print head having a nozzle plate, and one or more ink reservoirs fluidically connected to the nozzle plate. A typical nozzle plate may include arrays of different nozzles such as color nozzles and mono nozzles. These arrays of nozzles are suitably connected to the ink reservoirs and facilitate the ejection of droplets of ink to make marks on a media. Such thermal inkjet cartridges utilize a low level of vacuum to contain the ink within the print heads prior to installation in inkjet printers by a customer. Changes in atmospheric pressure, as well as shock and vibration, require sealing of nozzles of the print bead to avoid any leakage of the ink during shipment of the thermal inkjet cartridges. Leakage during the shipment of the thermal inkjet cartridges may permit ink to soil the customer's hands or clothing. Ink leakage may also cause cross-contamination between different ink colors that may result in print quality defects at start-up.

Therefore, manufacturers of thermal inkjet cartridges have developed several techniques to seal the nozzles during shipment and handling of these cartridges. One such technique involves applying a thermoplastic (hot-melt) polymer film on the nozzle plate in order to cover exit regions of the arrays of nozzles (hereinafter interchangeably referred to as ‘nozzle orifices’) of the print head. However, such thermoplastic tapes do not adhere well to the print head due to irregularities in the nozzle plate surface. Further, thermoplastic tapes may leave adhesive residue on the nozzle orifices of the print head, which may result in misdirected drop trajectories.

Another technique to seal the nozzle plate is a Pressure Sensitive Adhesive (PSA) tape approach, which involves adhering tape onto a top surface of the print head and then pressing the tape by materials, which include, but are not limited to, a piece of plastic foam onto the PSA tape. However, such a covering of the plastic foam cover requires additional space, cost, and packaging. The top surface of the print head of the inkjet printer may be uneven or irregular. In such a print head, tape materials along with the plastic foam do not easily accommodate such unevenness and therefore may leave gaps between the nozzle plate of the print head and the PSA tape, resulting in leakage of the ink. The PSA tape may affect a nozzle seal by deformation and flow of adhesive material of the PSA tape into the nozzle, which may be sufficient to form a dimple or a shallow plug (for example, approximately equal to four microns deep).

Apart from these techniques, existing leakage prevention techniques also utilize an Ultraviolet (UV) curable sealant approach. The UV curable sealant approach involves dispensing a liquid sealant onto each nozzle and subsequently curing the sealant with ultraviolet energy prior to shipment of the inkjet cartridge. The UV curable sealant approach to nozzle sealing typically forms larger dimples of sealants into the nozzles than the PSA tape approach (the sealant penetrates into the nozzles further than from a PSA tape). The formation of sealant dimples of sufficient height helps prevent ink from exiting from the nozzles during the shipment of the inkjet cartridge. Further, a UV curable sealant approach to the sealing of each nozzle also requires that the depth of sealant penetration into each nozzle should not exceed a predetermined maximum depth. In addition, the UV curable sealant approach to the sealing of each nozzle requires that no residual sealant material should be left on the nozzle plate or in the nozzles upon UV sealant removal. Residual sealant material left on the nozzle plate or in the nozzles may result in undesirable variances such as missing and/or misdirected nozzles, which degrade print quality.

Shipping and handling prior to installation of the inkjet cartridges often cause or at least aggravate the undesirable variances, which are mentioned above. The inkjet cartridge may get jostled and tilted during shipment and installation, which can cause ink to leak from the nozzles into packaging of the inkjet cartridge, thereby wasting ink and resulting in additional time and effort in cleaning the print head. Further, the nozzles may become clogged with dry ink or debris in between the time the inkjet cartridge is packaged for shipping and installed in a printer.

As illustrated above, there exists a need in the industry for an improved sealant applicator that addresses deficiencies in the existing sealing products, some of the deficiencies having been discussed above.

### SUMMARY OF THE INVENTION

In one aspect, the present invention provides a sealant applying apparatus for dispensing sealant onto a nozzle plate of a print head. The nozzle plate comprises a plurality of arrays of nozzles. Each array of nozzles of the plurality of arrays of nozzles has a predefined perimetric profile of a nozzle orifice. The sealant applying apparatus comprises a barrel and a sealant tip. The barrel is configured to enclose the sealant therein. The sealant tip extends from an end of the barrel and comprises a plurality of sealant outlets. Each sealant outlet of the plurality of sealant outlets is configured to dispense sealant onto an array of nozzles of the plurality of arrays of nozzles. Further, each sealant outlet is configured such that at least one of a height of each sealant outlet and a perimeter of an exit of each sealant outlet depends upon a predefined perimetric profile of a nozzle orifice of the array of nozzles.

In another aspect, the present invention provides a sealant applying apparatus for dispensing sealant onto a nozzle plate of a print head. The nozzle plate comprises a plurality of arrays of nozzles. Each array of nozzles of the plurality of arrays of nozzles has a predefined perimetric profile of a nozzle orifice. The sealant applying apparatus comprises a plurality of barrels and a sealant tip. The plurality of barrels are juxtaposed to each other and are configured to enclose sealant therein. The sealant tip comprises a plurality of sealant outlets. Each sealant outlet of the plurality of sealant outlets extends from an end of a barrel of the plurality of barrels. Each sealant outlet is configured to dispense sealant onto an array of nozzles of the plurality of arrays of nozzles. Further, each sealant outlet is configured such that at least one of a height of each sealant outlet and a perimeter of an exit of each sealant outlet depends upon a predefined perimetric profile of a nozzle orifice of the array of nozzles.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic diagram, depicting an exemplary sealant applying apparatus embodying the present invention;

FIGS. 2A and 2B are response contour plots of dimple depths based on an experiment performed on an Ablated Flow Features (AFF) nozzle plate;

FIGS. 3A and 3B are response contour plots of dimple depths based on an experiment performed on a Photo Imageable Nozzle Plate (PINP);

FIG. 4 is a plot representing variation of the dimple depths for the eight cells in an experiment conducted on the AFF nozzle plate;

FIG. 5 is a plot representing variation of the dimples depths for the eight cells in an experiment conducted on the PINP nozzle plate; and

FIG. 6 is a schematic diagram, depicting another exemplary sealant applying apparatus embodying the present invention.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The present invention provides a sealant applying apparatus for dispensing sealant onto a nozzle plate of a print head of an inkjet printer. The nozzle plate of the print head comprises a plurality of arrays of nozzles. The plurality of arrays of nozzles may include, but is not limited to, multiple arrays of color nozzles and/or arrays of mono nozzles. For example, the arrays of color nozzles may include different type of color nozzles such as a cyan nozzles array, a magenta nozzles array, and a yellow nozzles array. Each of the cyan nozzles array, the magenta nozzles array, and the yellow nozzles array includes a plurality of cyan nozzles, a plurality of magenta nozzles and a plurality of yellow nozzles, respectively. A typical cyan nozzle represents a nozzle which is configured to eject cyan ink from a corresponding ink reservoir. Similarly, a magenta nozzle and a yellow nozzle refer to nozzles connected to a magenta ink reservoir and a yellow ink reservoir, respectively. Further, the arrays of mono nozzles may include, but are not limited to, mono (K1) nozzles array and mono (K2) nozzles array. Herein, on a typical print head, the mono (K1) nozzle array and the mono (K2) nozzle array only differ in their position on the print head. Since a significant portion of printing done on an inkjet printer is black and white, inkjet print heads often have more mono nozzles than color nozzles (to improve printing speeds). Specifically, the mono (K2) nozzle array may be the outermost array while the mono (K1) nozzle array being adjacent to the magenta nozzles array on the print head.

Each array of nozzles has a predefined perimetric profile of nozzle orifices. Herein, a nozzle orifice represents an opening of a nozzle, which enables the ink to expel from the nozzle. Each nozzle orifice in an array of nozzles has a predefined perimetric profile, for example, diameters, or lengths and widths for each nozzle orifice may be equal in a single array of nozzles. For example, each nozzle of the mono (K2) nozzles array may have a Oval-shaped nozzle orifice of 15 microns in width and 17 microns in length. Similarly, each nozzle of the cyan nozzles array may have circular nozzle orifice having a diameter of 14 microns.

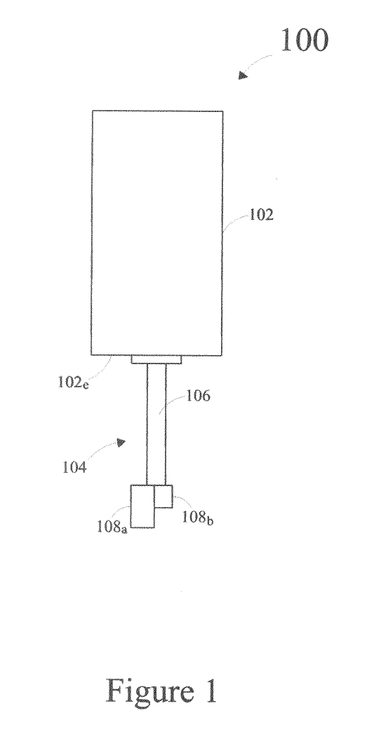

Referring now to the drawings and particularly to FIG. 1, an exemplary representation of a sealant applying apparatus 100 is shown. FIG. 1 represents a front view of the sealant applying apparatus 100. Sealant applying apparatus 100 may be used for dispensing sealant onto the nozzle plate (not shown) of the print head (not shown). More specifically, sealant applying apparatus 100 is configured to dispense sealant onto each nozzle of the plurality of arrays of nozzles, where each of the arrays of nozzles may have a distinct perimetric profile of nozzle orifice. Sealant applying apparatus 100 includes a barrel 102 and a sealant tip 104. Barrel 102 is configured to enclose sealant therein. Typically, barrel 102 includes a sealant chamber (not shown) to include the sealant therein. Barrel 102 may be of any suitable shapes to contain sealant such as of a cylindrical shape, a cubical shape, or a cuboidal shape.

Sealant tip 104 is connected to an end 102ₑ of barrel 102. In an embodiment of the present invention, sealant tip 104 includes a needle 106 and a plurality of sealant outlets such as a sealant outlet 108ₐ and a sealant outlet 108_{b}. Needle 106 may be of a tubular shape that facilitates a flow of sealant from barrel 102 to sealant outlets 108ₐ and 108_{b}. Each of sealant outlets 108ₐ and 108_{b} are specifically configured for the dispensing of sealant to a respective array of nozzles having a uniform perimetric profile of the nozzle orifices of the array of nozzles.

For example, sealant outlet 108ₐ may be configured to dispense sealant onto nozzles of the cyan nozzles array having a nozzle orifice perimetric profile of 14 microns in diameter. Similarly, sealant outlet 108_{b} may be configured to dispense sealant onto the nozzles of the mono (K2) nozzles array. In FIG. 1, only two sealant outlets, such as sealant outlets 108ₐ and 108_{b}, are shown for the purpose of description only and should not be considered limiting in any way. It will be apparent to a person skilled in the art that the plurality of sealant outlets may include any number of sealant outlets. In one embodiment of the present invention, the number of sealant outlets in sealant tip 104 may be chosen depending on the number of arrays of nozzles on the nozzle plate of the print head. The number of sealant outlets, when equal to the number of different arrays of nozzles may facilitate completion of the sealant dispensing process in a single pass.

Herein, as shown in FIG. 1, sealant outlets 108ₐ and 108_{b} are of different geometrical dimensions. More specifically, each of sealant outlets 108ₐ and 108_{b} are configured depending on the perimetric profile of the nozzle orifices of their respective nozzles array. For example, at least one factor such as a height and a perimetric profile of sealant outlet 108ₐ may be chosen based on the perimetric profile of the nozzle orifices of the cyan nozzles array. Similarly, at least one factor such as a height and a perimetric profile of sealant outlet 108_{b} may be chosen based on the perimetric profile of the nozzle orifices of the mono (K2) nozzles array. Configuring sealant outlets 108ₐ and 108_{b}, based on the perimetric profiles of nozzle orifices of their respective nozzles arrays, provides a formation of dimples of appropriate depths within a predetermined minimum depth and predetermined maximum depth, which may be removed after a UV cure process. In the description following, the term ‘dimple’ refers to sealant that has been dispensed in a nozzle.

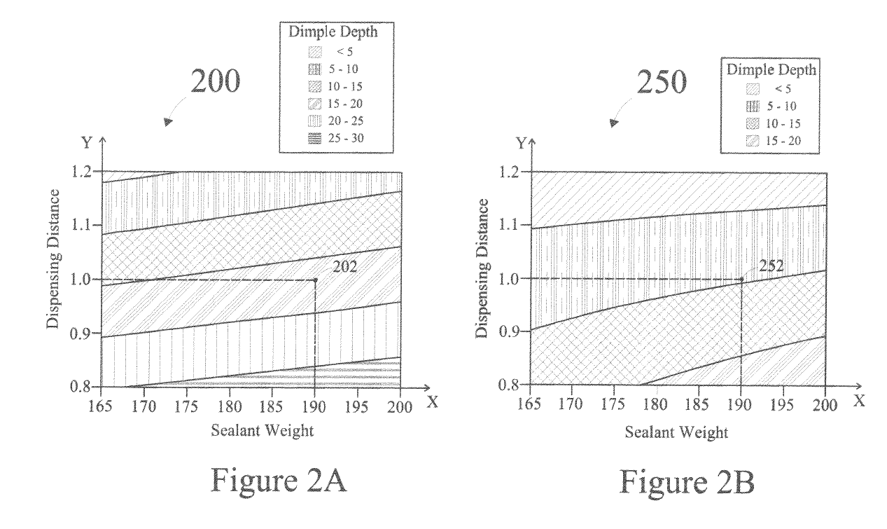

The requirement of sealant tip 104 including the plurality of sealant outlets such as sealant outlets 108ₐ and 108_{b} having geometries based on the perimetric profiles of their respective nozzle orifices may be explained with the help of an experiment performed in a Design of Experiment (DOE). The responses of the experiment are explained in conjunction with Table 1 and FIGS. 2A to 5. Herein, in the experiment, the DOE includes a plurality of arrays of nozzles. For example, the DOE includes five arrays such as the mono (K1) nozzles array, the mono (K2) nozzles array, the cyan nozzles array, the magenta nozzles array and yellow nozzles array. Each of the five arrays of nozzles includes 640 nozzles.

The experiment incorporates use of a sealant applying apparatus having a sealant tip, which has a plurality of sealant outlets. The plurality of sealant outlets have the same geometrical specifications, i.e., the geometry of the plurality of sealant outlets is independent of the perimetric profile of the nozzle orifices of their respective array of nozzles. Further, the sealant applying apparatus is used to dispense sealant over the nozzle plate in a single pass in order to minimize cycle time. However, dispensing sealant onto the nozzle plate, when the nozzle plate is a Photo Imageable Nozzle Plate (PINP) containing mono nozzles arrays and color nozzles arrays on the same substrate, with a single pass of the sealant tip may result in dimples of varying depths. For example, the mono dimple depth may be substantially different than the color dimple depth.

There are numerous factors that affect the dimple depth of sealant penetration in a nozzle. These factors includes, but are not limited to, viscosity of sealant, temperature of the sealant applying apparatus, design of the sealant applying apparatus, dispense technique such as dispensing in a single pass or in multiple passes, density of sealant, time duration from the end of the sealant dispensing process to the UV cure process. It will be obvious to a person skilled in the art that a set of sealant dispensing conditions developed to optimize mono dimple depth will create dimples too short within the smaller exit diameter of color nozzles. Similarly, dispense operating conditions set to optimize color dimple depth, may create dimples that are too deep within the mono nozzles array.

Apart from these factors, there are factors that predominantly affect the dimple depth in the nozzle such as, dispensing distance of sealant onto the nozzle and the perimetric profile of the nozzle orifice of the nozzle. The dispensing distance of sealant onto the nozzle may refer to a distance between a sealant outlet of the sealant applying apparatus and the nozzle plate. A result of the experiment represents a dependence of the dimple depth within nozzles on these factors, which may be further used to design sealant applying apparatus 100.

The experiment utilizes eight combinations of three factors, i.e., the dispensing distance, the sealant weight and the sealant tip temperature for the purpose of experimentation. Each factor has two extreme values. Each combination of the factors at a single level is called a ‘cell’. A single print head consisting of a K1 nozzles array, a K2 nozzles array, a cyan nozzles array, a magenta nozzles array and a yellow nozzles array was utilized for each cell in the DOE. Further, the experiment involved running each cell twice on random nozzles from the 640 nozzles of each of the mono (K1) nozzles array, the mono (K2) nozzles array, the cyan nozzles array, the magenta nozzles array and the yellow nozzles array. The experiment incorporated two replicates for each cell, i.e., two print heads. A total of 16 trials for both Ablated Flow Features (AFF) nozzle plate and PINP nozzle plate were measured.

The present invention provides experimental results to analyze the impact of the factors such as the dispensing distance from the nozzles of different perimetric profiles of their nozzle orifices in the sealant dispensing process. The experiment was conducted with factors, such as, the dispensing distance, the sealant weight, and the temperature of the sealant tip. Each factor is set to two extreme values, called the levels of the factor. In the case of the factor, such as the dispensing distance, 1.2 millimeters (mm) is the high level, and 0.8 (mm) is the low level of the dispensing distance. Similarly, the high level of the sealant weight is selected as 200 milligrams (mg) and the low level of the sealant weight is selected as 165 milligrams (mg). The values of the factors are the exemplary values and are selected only for the purposes of the experiment. In a typical experiment, a computer application may list all combinations of the three factors with two levels each. An eight cell DOE with three factors at two levels each is shown for reference in Table 1. Table 1 lists eight cells for the eight combinations of factors. The results of the experiment by running each of the eight cells has been illustrated and described in conjunction with FIGS. 2A to 5.

TABLE 1

| | Dispensing | Sealant Weight | Sealant Tip |
|---|---|---|---|
| Cell | Distance (mm) | (mg) | Temperature (C.) |
| 1 | 0.8 | 165 | 26 |
| 2 | 1.2 | 200 | 26 |
| 3 | 0.8 | 165 | 30 |
| 4 | 0.8 | 200 | 30 |
| 5 | 1.2 | 165 | 26 |
| 6 | 0.8 | 200 | 26 |
| 7 | 1.2 | 165 | 30 |
| 8 | 1.2 | 200 | 30 |

Referring to FIGS. 2A and 2B, response contour plots of dimple depths for mono (K2) dimples, and cyan dimples are shown, respectively. Response contour plots 200 and 250 have been obtained by the experiment conducted by running eight cells of the DOE. Response contour plot 200 of FIG. 2 A represents the variation of dimple depth for the mono (K2) dimples (representation in distinct shades), as the dispensing distance (Y-axis) varies with respect to the sealant weight (X-axis) at a constant sealant tip temperature for the AFF print head. Similarly, response contour plot 250 of FIG. 2B represents the variation of dimple depth (representation in distinct shades) for the cyan dimples, as the dispensing distance (Y-axis) varies with respect to the sealant weight (X-axis) for the AFF nozzle plate. Response contour plots 200 and 250 used for the experiment are plotted by keeping the sealant tip temperature of the sealant applying apparatus constant.

By analyzing response contour plots 200 and 250, it is obvious that the mono (K2) dimple depths are typically greater than the cyan dimple depths for input trial conditions of sealant weight with respect to the dispensing distance from the nozzle plate while holding the sealant tip temperature constant. For example, for a value of the dispensing distance of 1.0 mm and sealant weight of 190 mg, the value of dimple depth for the mono (K2) nozzles is between 15 microns to 20 microns (see point 202 in FIG. 2A) and the value of dimple depth for the cyan nozzles is between 5 microns to 10 microns (see point 252 in FIG. 2B).

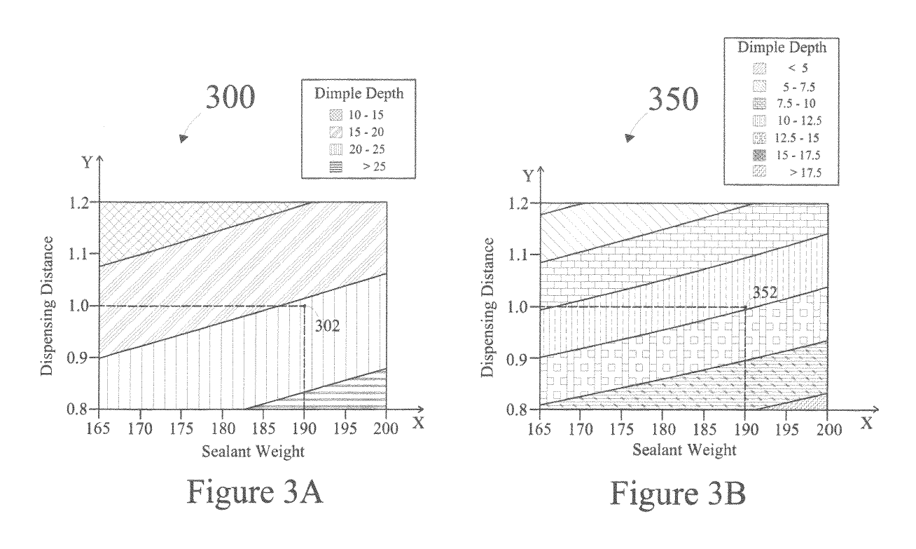

Similarly, eight cell DOE contour plot results such as a response contour plot 300 and a response contour plot 350 are shown for the PINP nozzle plate in FIGS. 3A and 3B, respectively. Response contour plot 300 represents a variation of dimple depth for the mono (K2) dimples (representation in distinct shades), as the dispensing distance (Y-axis) varies with respect to the sealant weight (X-axis). Similarly, response contour plot 350 represents a variation of dimple depth for the cyan dimples, as the dispensing distance (Y-axis) varies with respect to the sealant weight (X-axis). Response contour plots 300 and 350 are plotted by keeping the sealant tip temperature of the sealant applying apparatus constant.

Further, by analyzing response contour plots 300 and 350, it is obvious that the mono (K2) dimple depths are typically larger than the cyan dimple depths for input trial conditions of the sealant weight with respect to the dispensing distance from the nozzle plate while holding the sealant tip temperature constant. For example, for a value of dispensing distance of 1.0 mm and sealant weight of 190 mg, the value of dimple depth for the mono (K2) nozzles is between 20 microns to 25 microns (see point 302 in FIG. 3A) and the value of dimple depth for the cyan nozzles is between 10 microns to 12.5 microns (see point 352 in FIG. 3B).

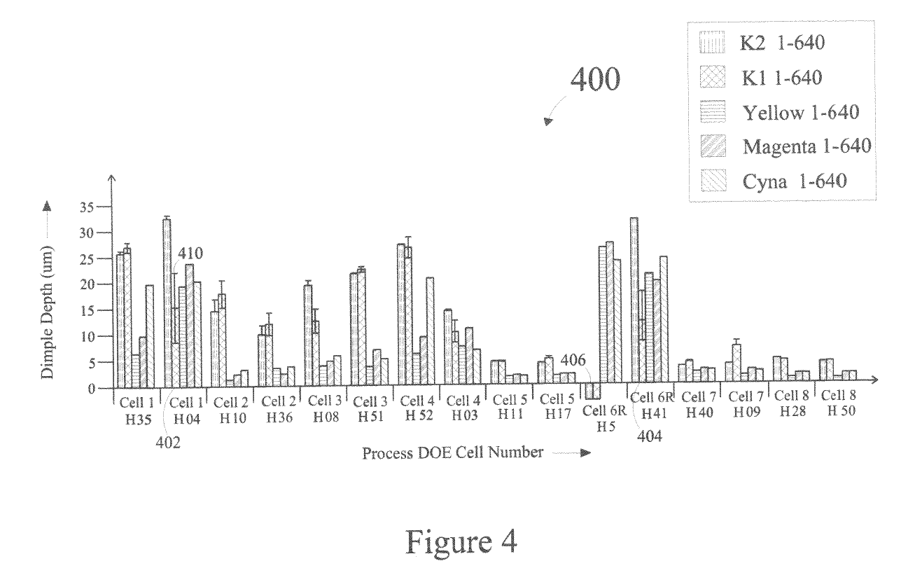

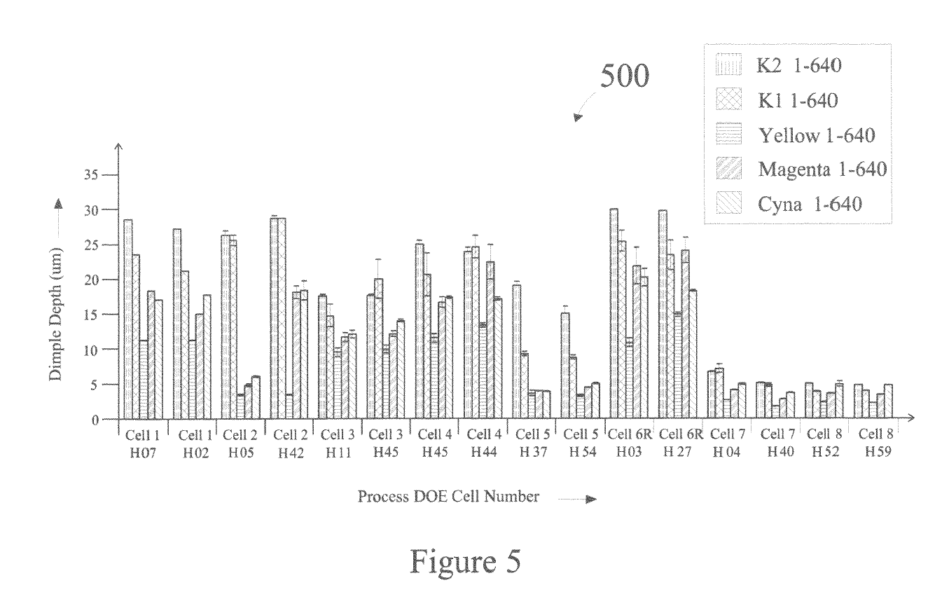

A comparison for all eight cells of the DOE experiment for AFF and PINP nozzles is shown in FIGS. 4 and 5, respectively. FIGS. 4 and 5 represent plots including variation of dimple depths with respect to the random heads of the DOE based on the experiment by running the three factors of the eight cells two times.

The output measurement or response of each combination of the three factors of the cell (the dispensing distance, the sealant weight and the sealant tip temperature), is the dimple height, i.e., the depth of penetration of sealant into the nozzle. For each cell, the dimple depth response for random nozzles of the 640 nozzles of each of the five arrays, i.e., the mono (K1) nozzles array, the mono (K2) nozzles array, the cyan nozzles array, the magenta nozzles array, and the yellow nozzles array, are shown in FIGS. 4 and 5. Only the average of eight dimples for each of the five arrays are shown, which may be representative of the variation of dimple depth along each nozzles array. More specifically, the experiment involved use of two replicates for each cell for a total of 16 trials for both the AFF nozzle plate and the PINP nozzle plate, which are shown in FIGS. 4 and 5, respectively.

Referring now to FIG. 4 in particular, a plot 400 is represented, which illustrates a comparison of the eight cells with respect to dimple depths obtained by running each of the eight cells with AFF nozzle plate heads in the experiment. Specifically, plot 400 represents variation of dimple depths for the 16 trials, which are performed by running eight cells in a replicate manner on print heads with AFF nozzle plates. Herein, a trial refers to a data sample obtained by measuring the dimple depth from a nozzle of the nozzle plate of a print head in the DOE, and an order of the trial for different combinations of factors may be generated by a computer program in a random order. Plot 400 includes arrows 402, 404 and 406, which indicate trials that resulted in fractured dimples in the respective nozzles. For example, arrow 402 represents a fractured dimple in head 4 (shown as ‘H 04’ in plot 400) of the mono (K1) nozzles array for cell 1. Similarly, arrow 404 represents a fractured dimple at head 41 (shown as ‘H 41’ in plot 400) of the mono (K1) nozzles array for the cell 6R. Herein, cell 6R represents the cell 6, where the dimple depth is measured a second time, i.e., for the second replicate of the cell 6. The arrows 402 and 404 represent fractured dimples of a few microns, which is evident by a high standard deviation of dimple depth (represented by standard deviation 410). Herein, the standard deviation of average dimple depth (sample size of eight measurements for all arrays) shows the extent to which the dimple depth measurements vary within the eight dimples.

Arrow 406 in plot 400 represents a negative dimple for head 5 for each of the mono (K1) nozzles array and the mono (K2) nozzles array for the cell 6R. Herein, negative dimples may represent a trial where a dimple breaks off in a nozzle during UV sealant removal. Both positive and negative dimples may be identified with a scanning tool such as a Veeco™ optical profilometer. In fact, a fractured dimple may remain in the nozzle. The presence of sealant in the nozzle may also be confirmed by an Infrared (IR) materials analysis.

Further, referring specifically to FIG. 5, a plot 500 is represented, which illustrates a comparison of the eight cells of the experiment in terms of dimple depths obtained by running each of the eight cells with PINP nozzle plates. Specifically, plot 500 represents variation of dimple depths for 16 trials, which are performed by running eight cells in a replicate manner on the DOE print heads with PINP nozzle plates. By the analysis of plot 500, it is evident however that no fractured dimples are measured for the PINP nozzle plates, but the PINP nozzle plates showed responses similar to the AFF nozzle plates as shown in plot 400. In addition, combinations of factors in cells 5, 7 and 8 lead to smaller dimples for the mono nozzles arrays and the color nozzles arrays. Cells 5, 7 and 8 also showed the least variation in height between mono dimples and color dimples.

Based on the description of plots 200, 250, 300, 350, 400 and 500, it will be evident that the dispensing distance and the sealant weight are major contributory factors in the sealant dispensing process, which affects dimple depths in the nozzles. It will be obvious to a person skilled in the art that dispensing sealant onto the print head from a single dispense tip height results in a greater dimple depth into the mono nozzles than that of the color nozzles as the perimeter of the nozzle orifices of the mono nozzles is larger than that of the color nozzles. For example, consider a case where a sealant tip having a plurality of similar sealant outlets is used to dispense sealant onto the plurality of arrays of nozzles. The plurality of similar sealant outlets are designed having dimensions in order to facilitate the dispensing of a bead of sealant, which is sufficient to cover each of the plurality of nozzles arrays without exceeding width restrictions of the nozzle plate. Such a sealant tip having a single type of sealant outlets dispenses sealant from a single height from the nozzle plate. Specifically, such a sealant tip has an equal dispensing distance from each of the plurality of arrays of nozzles.

Therefore, it will be obvious that dispensing sealant from the single height from the nozzle plate results into sub-optimal dimple heights for the mono nozzles, the color nozzles, or both, due to the differences in the perimetric profile of their nozzle orifices. Further, there is also a difference in the widths of the mono nozzles array and the color nozzles array. Moreover, the mono nozzles and the color nozzles require different perimetric profile nozzle exit diameters depending on the differences in ink drop mass required based on print quality considerations. However, a single dispense needle tip may be utilized to dispense sealant onto the nozzle plate in multiple dispense passes. For example, with a nozzle plate containing mono nozzles arrays and color nozzles arrays in a first dispense pass, sealant may be dispensed onto the mono nozzles array from a first dispensing height, and in a second dispense pass, sealant may be dispensed onto the color nozzles arrays from a second dispensing height. This approach however results in additional flow time into the mono nozzles arrays, which are dispensed in the first dispense pass and are not immediately cured, thereby allowing additional and undesirable variations in the sealant dispensing process. Moreover, the cycle time for a multi-pass dispense operation would be longer than a single pass operation which is not desirable from a manufacturing standpoint. In addition, a single uniform width of sealant tip may not be optimum for either the mono nozzles array or the color nozzles array, as these arrays require a separate dispense path width dimension.

The results of the above DOE experiment may be used to identify an appropriate dispensing distance of the sealant tip from the nozzle plate, as the dispensing distance is critical to assessment of dimple depths and control of the sealant dispensing process. This requires the need for the design of the sealant tip by taking into account the factors such as the dispensing distance and the sealant weight. Further, the width of an array of nozzles may also be taken into account to design the sealant tip.

Therefore, the present invention provides sealant applying apparatus 100 having sealant tip 104, which includes the plurality of sealant outlets such as sealant outlets 108ₐ and 108_{b} as shown in FIG. 1. Each of sealant outlets 108ₐ and 108_{b} is designed for an array of nozzles having a particular perimetric profile of nozzle orifice. Sealant applying apparatus 100 may be used to dispense sealant onto the nozzle plate having a multitude of perimetric profiles of nozzle orifices. It will be apparent from FIG. 1 that the dispensing distance of sealant outlet 108ₐ is less than the dispensing distance of sealant outlet 108_{b}. Such configurations of sealant outlets 108ₐ and 108_{b} facilitate the appropriate dimple depths in the cyan nozzles and the mono (K2) nozzles, as obtained from the experiments that the dispensing distance for the cyan nozzles should be less than the dispensing distance for a mono (K2) nozzle. Further, in one embodiment of the present invention, the width of sealant outlet 108ₐ may be more than the width of sealant outlet 108_{b} as the width of the arrays of color nozzles may be more that the width of the arrays of mono nozzles.

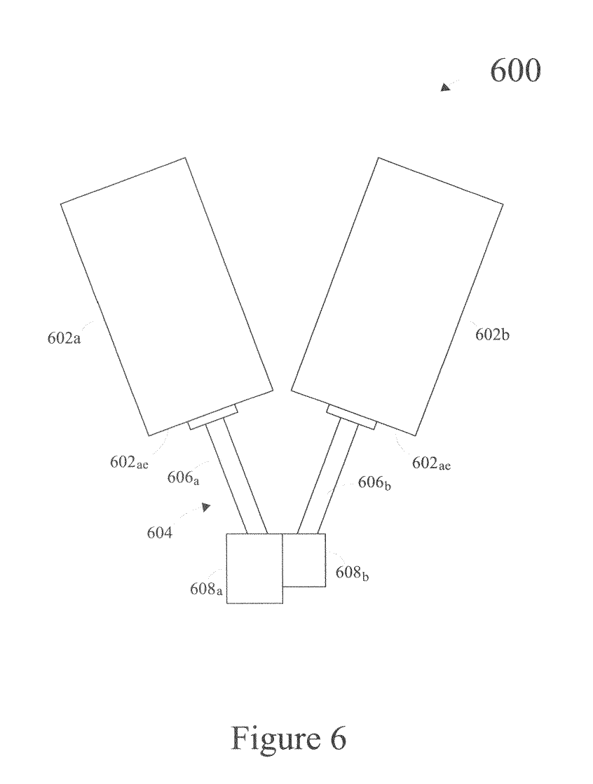

In another embodiment, the present invention provides a sealant applying apparatus 600 as shown in FIG. 6. Sealant applying apparatus 600 is similar to sealant applying apparatus 100 except for the fact that sealant applying apparatus 600 uses a plurality of barrels such as a barrel 602ₐ and 602_{b} instead of a single barrel such as barrel 102 used in sealant applying apparatus 100.

Sealant applying apparatus 600 includes a sealant tip 604, which has a plurality of sealant outlets such as a sealant outlet 608a and a sealant outlet 608_{b}. Each of sealant outlets 608ₐ and 608_{b} is connected to the plurality of barrels through a plurality of needles. More specifically, sealant outlet 608ₐ is connected to an end 602_{be} of barrel 602ₐ through a needle 606ₐ. Similarly, sealant outlet 608_{b} is connected to an end 602_{be} of barrel 602_{b} through a needle 606_{b}.

Use of multiple barrels such as barrels 602ₐ and 602_{b} may be advantageous from a sealant material processing and dispensing point of view. In one embodiment of the present invention, each of barrel 602ₐ and 602_{b} may be positioned juxtaposed to each other and sealant tip 604 may be a single entity, where plurality of sealant outlets such as sealant outlets 608ₐ and 608_{b} may be connected to each other.

The foregoing description of several embodiments of the invention has been presented for purposes of illustration. It is not intended to be exhaustive or to limit the invention to the precise steps and/or forms disclosed, and obviously many modifications and variations are possible in light of the above description. It is intended that the scope of the invention be defined by the claims appended hereto.

What is claimed is:

1. A sealant applicator for dispensing sealant onto a nozzle plate of a print head, the nozzle plate having a plurality of nozzle arrays, each nozzle array having a perimetric profile of a nozzle orifice, the sealant applicator comprising:
a barrel configured to enclose the sealant therein; and
a sealant tip fluidically coupled to the barrel, the sealant tip including a plurality of sealant outlets, each of the sealant outlets being configured to dispense the sealant onto at least one of the nozzle arrays,
wherein at least one of a height of each sealant outlet and a perimeter of an exit of each sealant outlet is determined based at least in part on the perimetric profile.

2. The sealant applicator of claim 1, wherein the sealant tip further comprises a needle, the needle extending from an end of the barrel to the plurality of sealant outlets.

3. The sealant applicator of claim 1, wherein at least two of the plurality of sealant outlets have different dimensions.

4. The sealant applicator of claim 1, wherein each of the plurality of sealant outlets have different dimensions.

5. The sealant applicator of claim 4, wherein the different dimensions of each of the plurality of sealant outlets correspond to different perimetric profiles of the associated nozzle arrays.

6. A sealant applicator for dispensing sealant onto a nozzle plate of a print head, the nozzle plate including a plurality of nozzle arrays, each nozzle array having a perimetric profile of a nozzle orifice, the sealant applicator comprising:
a plurality of barrels, each of the plurality of barrels being configured to enclose the sealant therein, and each of the barrels disposed adjacent one another; and
a sealant tip comprising a plurality of sealant outlets, each sealant outlet fluidically coupled to one barrel, each sealant outlet configured to dispense sealant onto at least one of the nozzle arrays.
wherein at least one of a height of each sealant outlet and a perimeter of an exit of each sealant outlet depends upon the perimetric profile of the associated nozzle array.

7. The sealant applicator of claim 3, further comprising a plurality of needles, each of the needles extending from one of the barrels to at least one of the sealant outlets.
